(19) United States
(12) Patent Application Publication
(10) Pub. No.: US 2025/0148220 A1
(43) Pub. Date: May 8, 2025

(54) INTERPRETING LARGE LANGUAGE MODELS

(71) Applicant: Microsoft Technology Licensing, LLC, Redmond, WA (US)

(72) Inventors: Aditya Vithal NORI, Cambridge (GB); Javier GONZÁLEZ HERNÁNDEZ, Cambridge (GB)

(21) Appl. No.: 18/592,468

(22) Filed: Feb. 29, 2024

Related U.S. Application Data
(60) Provisional application No. 63/596,212, filed on Nov. 3, 2023.

(51) Int. Cl. G06F 40/40

(52) U.S. Cl. CPC G06F 40/40

(57) ABSTRACT

Example solutions for processing LLM prompts include creating a first large language model (LLM) prompt based on an input LLM prompt. The first LLM prompt represents a first step toward generating a solution to the input LLM prompt. The first LLM prompt is submitted to an LLM as a first sub-query, thereby resulting in the generation of a first LLM output. A second LLM prompt is generated based on the input LLM prompt. The second LLM prompt represents a second step toward generating the solution. The second LLM prompt includes the first LLM output. The second LLM prompt is submitted to the LLM as a second sub-query, thereby resulting in the generation of a second LLM output. The second LLM output represents the solution to the input LLM prompt in response to the input LLM prompt.

### CROSS-REFERENCE TO RELATED APPLICATIONS

This application claims the benefit of U.S. Provisional Patent Application No. 63/596,212 filed on Nov. 3, 2024, which is hereby incorporated by reference herein in its entirety.

### BACKGROUND

Large language models (LLMs) are powerful tools that can comprehend natural language text and other complex information, and generate text responses to various input prompts, such as queries or commands. To interact with an LLM, a human user provides a prompt and receives a response from the model, which is based on its internal algorithms. The user then evaluates the response and decides whether it answers the prompt satisfactorily. This process may be repeated several times until the user reaches a desired outcome (or gives up).

Current LLMs, such as PaLM, GPT-4, and LLAMA, can exhibit both remarkable and baffling behaviors, depending on the task. In evaluating what causes these discrepancies, research has primarily focused on testing LLMs on different tasks so the user can gain insights about their behavior. For GPT-4, a large collection of behaviors has been studied on several tasks. Benchmarking efforts have been conducted in various domains such as causal discovery, summarization, and reasoning. These research directions are reasonable, given that most LLMs are blackboxes that cannot easily be inspected, interpreted, or explained. However, the field lacks a mathematical framework to systematically describe, compare, and improve LLMs.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Example solutions for processing LLM prompts include: receiving an input large language model (LLM) prompt; creating a first LLM prompt based on the input LLM prompt, the first LLM prompt representing a first step toward generating a first solution to the input LLM prompt; submitting the first LLM prompt to an LLM as a first sub-query, thereby resulting in the generation of a first LLM output; creating a second LLM prompt based on the input LLM prompt, the second LLM prompt representing a second step toward generating the first solution to the input LLM prompt, the second LLM prompt including the first LLM output; submitting the second LLM prompt to the LLM as a second sub-query, thereby resulting in the generation of a second LLM output; and transmitting the second LLM output as the solution to the input LLM prompt.

### BRIEF DESCRIPTION OF THE DRAWINGS

The disclosed examples are described in detail below with reference to the accompanying drawing figures listed below:

FIG. 1 is an example LLM analytics system;

FIG. 2 shows a diagram representing an example problem;

FIG. 3 illustrates an example prompt and associated LLM output;

FIG. 4 illustrates another example prompt and associated LLM output;

FIG. 5 and FIG. 6 illustrate diagrams that the LLM analytics device creates to apply chain-of-thought (CoT) reasoning to prompts for the LLM;

FIG. 7 illustrates an example zero-shot prompting task for a problem;

FIG. 8 illustrates another example in which CoT prompting is used with the LLM;

FIG. 9 illustrates another example in which the LLM analytics device uses CoT reasoning with the LLM to draw the correct figure using several intermediate prompts and evaluating several intermediate outputs;

FIG. 10 is an example diagram that illustrates self-verification under an example framework;

FIG. 11 provides an example illustration of self-verification with generation and verification in the same prompt;

FIG. 12 illustrates splitting the problem into several intermediate prompts to the LLM, rather than one unified prompt;

FIG. 13 illustrates an example of using the Python API to write a zero-shot prompt for adding two numbers;

FIG. 14 illustrates another example in which the same API also supports few-shot learning, which uses some examples of questions and answers that are related to the query;

FIG. 15 illustrates an example of using the same API to create CoT prompts by providing the assistant with step-by-step solutions of the examples as its input;

FIG. 16 is a flowchart illustrating an example computer-implemented method; and

FIG. 17 is a block diagram of an example computing device (e.g., a computer storage device) for implementing aspects disclosed herein.

Corresponding reference characters indicate corresponding parts throughout the drawings. Any of the drawings may be combined into a single example or embodiment.

### DETAILED DESCRIPTION

In examples, a system and associated framework are described that clarify key terms and concepts in large language model (LLM) research such as, for example, hallucinations, alignment, self-verification and chain-of-thought reasoning. The system offers a precise and consistent way to characterize LLMs, identify their strengths and weaknesses, and integrate new findings. The system differentiates chain-of-thought reasoning from chain-of-thought prompting and establishes the conditions under which they are equivalent. This distinction clarifies the basic assumptions behind chain-of-thought prompting and its implications for methods that use it, such as self-verification and prompt programming.

The system described herein provides a formal framework for LLMs that helps both researchers and practitioners explore new possibilities for generative artificial intelligence (AI). This system provides a tool for opening up new research avenues. The formal definitions and results described herein help advance the discussion on how to build generative AI systems that are safe, reliable, fair, and robust, especially in domains like healthcare and software engineering.

An example system offers a new perspective on interpreting LLMs and presents a mathematical framework that formalizes and generalizes what is known about LLMs. The system pursues at least two objectives. First, the system defines key LLM concepts such as alignment, hallucinations, and chain-of-thought reasoning using a proposed mathematical framework. Second, the system provides a reasoning tool that facilitates a common understanding of existing LLM research and forms a basis for exploring new questions and challenges. An example framework is based on commutative diagrams that relate different levels of abstraction and computation in LLMs. The framework is usable by researchers in LLMs to share, position, and reason about their findings. An example framework also captures the essence of LLMs as abstract execution machines that use natural language as an interface, which reveals the assumptions and implications of various methods that use LLMs, such as self-verification and prompt programming. An example framework also formalizes and evaluates the output of LLMs using distance metrics and compatibility relations.

The example system improves the performance of LLMs to avoid hallucinations and misalignments. The creation of multiple LLM prompts based on an initial input prompt and submitting those LLM prompts as sub-queries to the LLM allows the system to break the input prompt into several parts or steps toward generating a solution to the input LLM prompt. Such a divisional approach reduces the number of responses that have hallucinations or misalignments. When responses have such erroneous output, users typically reword and resubmit additional queries to the LLM. These additional queries add additional computational overhead to the LLM, as well as consumption of additional network bandwidth for the added queries and responses. The example system reduces the number of queries needed to generate accurate output, thus providing a technical improvement.

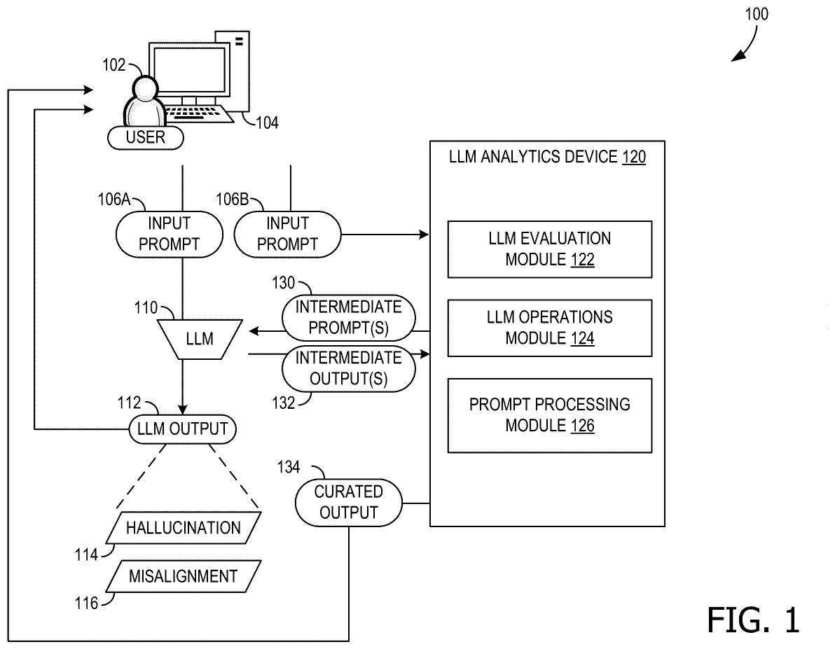

FIG. 1 is an example LLM analytics system 100. In this example, an LLM analytics device 120 is a computing device that provides various analytics and prompt engineering on behalf of a user 102 (e.g., via a user computing device 104). In examples, the LLM analytics device 120 includes an LLM evaluation module 122, an LLM operations module 124, and a prompt processing module 126. The LLM evaluation module 122 is configured to perform aspects of model training, configuration, and evaluation (e.g., to evaluate aspects of performance of the LLM 110 against classes of problems using training data). The LLM operations module 124 is configured to perform aspects of operational interactions with the LLM 110 such as, for example, submitting prompts to the LLM 110, receiving associated output from the LLM 110, and perhaps displaying such output (e.g., to the user 102). The prompt processing module 126 is configured to perform aspects of prompt engineering (e.g., prompt creation) and output evaluation (e.g., using LLM output to generate additional prompts or the like, as described herein).

While modules 122-126 are shown as provided by the LLM analytics device 120 for purposes of illustrating aspects of the system 100, it should be understood that any of the operations described herein can be provided by any of the modules 122-126 or other components of the LLM analytics system 100 not expressly shown. Further, while the example architecture shown in FIG. 1 describes many aspects of the system 100 as being performed by the LLM analytics device 120, it should be understood that any or all of these operations may be performed by other computing devices. For example, in some embodiments, the user computing device 104 is configured to perform any or all of the operations of the LLM analytics device 120 (e.g., as a mobile application architecture). In some embodiments, the LLM 110 is managed and provided by another computing device (not shown), such as via a cloud deployment of the LLM 110, as an online service via the Internet (e.g., as with GPT-*, ChatGPT and its variants, as made publicly available by OpenAI, BERT and its variants, as made publicly available by Google, and the like).

During operation, the LLM analytics system 100 uses an LLM 110 to process input prompts 106A, 106B (collectively, “input prompts 106”). In some examples, input prompts 106A are sent directly to the LLM 110 (e.g., from a user computing device 104) to generate LLM output 112. In other examples, an LLM analytics device 120 acts as an interface to the LLM 110 (e.g., for the user computing device 104), taking the input prompt 106B from the user computing device 104 and using the LLM 110 to generate curated output 134 given that prompt 106B.

The LLM 110 is an execution machine that uses natural language as an interface. More specifically, the LLM 110 is a type of artificial intelligence program designed to understand and generate human-like text based on the input received. The LLM 110 is built using a neural network (e.g., a transformer model), which is adept at handling sequential data, such as text. The LLM 110 is trained on a diverse and extensive dataset comprising, for example, text from books, websites, articles, and other written materials. This training enables the LLM 110 to learn language patterns, grammar, facts about the world, and various writing styles. Once trained, the LLM 110 can perform a range of language-related tasks, such as answering questions, writing essays, summarizing texts, translating languages, and creating content such as poems or code. The LLM 110 is designed to understand context from the text input received. As such, the LLM 110 can generate coherent and contextually relevant responses based on conversation history and the input text provided. Despite the capabilities, the LLM 110 can sometimes generate incorrect or nonsensical responses, especially when dealing with complex or ambiguous queries. The LLM 110 can also unintentionally propagate biases present in the training data.

In examples, given an input prompt 106 that captures the intentions of the user 102, the LLM 110 produces an output answer in the form of text that is presented to the user 102 (e.g., as LLM output 112, intermediate outputs 132, or curated output 134 via processing by the LLM analytics device 120). The prompt 106 aims to solve a problem such as, for example, a mathematical operation, a summarization, or the generation of a certain type of text. The prompt 106 expresses an intention to execute some operations based on some information provided by the user 102. The LLM 110, which in many senses operates as a “black box,” uses the internal memory acquired at training time to provide an answer by sampling from some probability distribution conditioned on the input prompt 106. This output 112 is computed by, for example, choosing the next word that best fits the previous text, and then repeating that process for each subsequent word.

In some examples, the input prompt 106B is received by the LLM analytics device 120, and the LLM analytics device 120 uses the prompt processing module 126 to break the problem presented by the input prompt 106B into multiple sub-problems. More specifically,

In examples, the system 100 provides a unified framework that formally defines example concepts for LLMs 110, including alignment (or misalignment 116), hallucinations 114, chain-of-thought reasoning, self-verification, and prompt programming. In these examples, a concrete state is defined as a function that assigns values from a concrete domain to a finite set of variables. V denotes a set of variables and C denotes a concrete domain. As such, σ: V→C indicates that σ is a concrete state. For example, suppose V={x,y} and C=Z, the set of integers. Then, one possible concrete state is σ={x→1, y→2}, which means that σ(x)=1 and σ(y)=2. The set of all concrete states over V and C is denoted by 2V-C.

Further, for an example problem, let q: 2^{V→C}→2^{V→C} be a query, and let σ be a concrete state. Informally, the query q expresses what a user wishes to compute over a state σ. For example, q might select some variables, apply some operations, or filter some conditions. As such, a problem is defined by the query-state pair (q,σ). A prompt is a natural language expression of a problem (q,σ) that the LLM 110 can solve. While examples provided herein separate elements to simplify this exposition, both elements can be mixed in some prompts. The prompt (q̅, σ̅) includes two strings, a query string q̅ that represents the query q in words, and a state string σ̅ that describes the concrete state σ in words. The set of all strings is denoted by T.

In examples, given a prompt (q̅, σ̅) as input (e.g., prompts 106), the LLM 110 (also denoted as LLM M) interprets this prompt to produce a natural language or string output. A state string σ̅ has a meaning that can be captured by a vector, which is an abstract state \hat{σ} or an embedding. The LLM 110 works with these vectors to manipulate state strings. The set of all abstract states is denoted as A. An abstraction map α is a function that transforms a concrete state σ into an abstract state \hat{σ}. The function α includes two sub-functions: (i) σ_{c}, which converts the concrete state σ to a state string σ̅ (e.g., as part of the prompt design process) and (ii) σₐ, which encodes the text state σ̅ into an abstract state \hat{σ} (e.g., by the LLM encoder). In other words, α(σ)=(σₐ∘σ_{c})(σ). A concretization map γ concretizes an abstract state \hat{σ} by producing a concrete state σ. The function γ includes two steps: (i) γₐ, which decodes the abstract state \hat{σ} into a state string σ̅ using the LLM (e.g., via an LLM decoder), and (ii) γ_{c}, which interprets the state string σ̅ as a description of the concrete output state (e.g., the human interpretation of the LLM output). In other words, γ(\hat{σ})=(γ_{c}∘γₐ) (\hat{σ}).

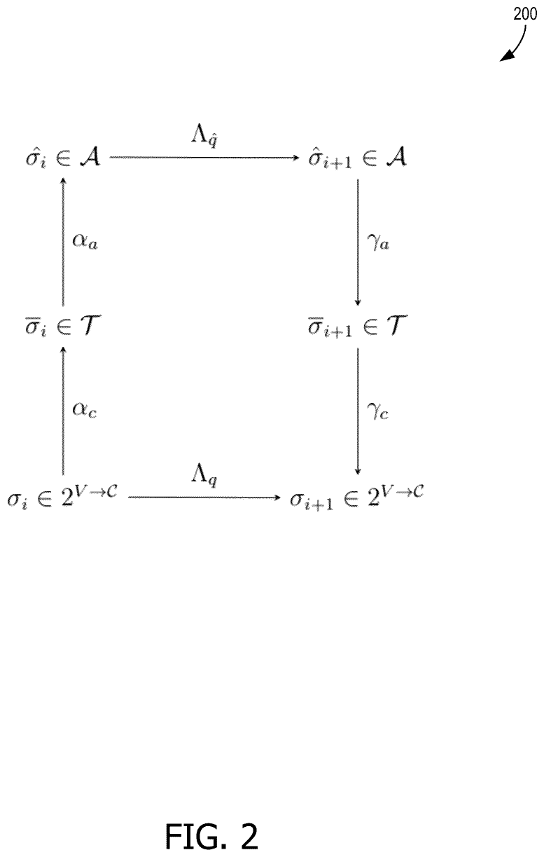

FIG. 2 shows a diagram 200 representing an example problem. In this example, the problem is defined as (q,σ), where q is a query (e.g., input prompt 106A, 106B, intermediate prompt 130) and σ is a concrete state. The diagram 200 is a commutative diagram with six edges, and the corners of the diagram 200 are states and the vertical and horizontal edges connect different levels of abstraction. In some examples, the LLM analytics device 120 may generate a graph (e.g., having nodes and edges as shown in FIG. 2) for the diagram 200 in internal memory. The vertical edges are based on the abstraction maps σ_{c} and σₐ, and the concretization maps γₐ and γ_{c}. The horizontal edges are based on the functionals Λ_{q} and Λ_{\hat{q}}, which computes the query q or its abstract counterpart \hat{q} on the corresponding states. These functionals are defined as follows:
Λ_{q}(σ) [symbol] q(σ) applies the query q to the concrete state σ; and
Λ_{\hat{q}}(\hat{σ}) [symbol] \hat{q}(\hat{σ}) computes the abstract query \hat{q} (e.g., being the interpretation of the LLM 110 of the query string q̅) on the abstract state \hat{σ}=α(σ).

In this example, the diagram 200 represents different ways or paths to solve a problem (q, σᵢ). Each path starts from an initial concrete state σᵢ and ends at a final concrete state σᵢ₊₁. The diagram 200 is commutative if and only if every path leads to a compatible σᵢ₊₁. In other words, if and only if Λ_{q}(σᵢ)=(γ_{c}∘γₐ∘Λ_{\hat{q}}∘αₐ∘α_{C})(σᵢ), where ≡ is a suitable compatibility relation. Additional examples of compatibility relations, such as equality, are provided below. Further, in this example, the path starting with the state string σ̅ᵢ and ending in the state string σ̅ᵢ₊₁ traces the execution of the LLM 110. The abstract states \hat{σ}ᵢ and \hat{σ}ᵢ₊₁ and the function Λ_{\hat{q}} are unobservable when the LLM 110 is a blackbox.

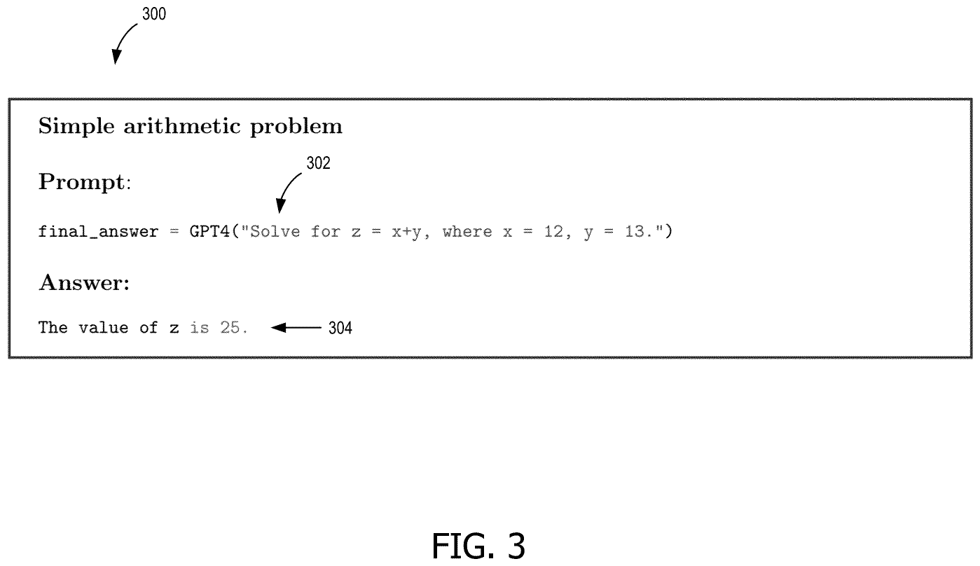

FIG. 3 illustrates an example prompt 302 and associated LLM output 304 for an example problem 300. In some examples, the prompt 302 may be similar to the prompts 106 of FIG. 1. In this example, the example problem 300 is a simple arithmetic problem that includes the prompt 302: “Solve for z=x+y where x=12, y=13” (expressed in FIG. 3 as a function call to “GPT4,” as an example LLM 110). As such, the system 100 defines an instance of this problem 300 as follows.

For concrete state, the set of variables V={x,y,z} is defined, where x, y, and z are the variables of the problem. The concrete domain C is the set of integers Z. The concrete initial state is defined as σᵢ={x→12, y→13, z→⊥}, where ⊥ represents an undefined value. The query is q=λσ. σ(x)+σ(y) and the problem 300 is the pair (q, σᵢ). The functional Λ_{q}(σᵢ) computes the concrete output state σᵢ₊₁. As such, σᵢ₊₁={x→12, y→13, z→25} is the correct answer that the user 102 expects from the LLM 110 (e.g., the “ground truth” of this example problem).

As an abstraction map, the function ac maps the concrete input state σᵢ to a state string σ̅ᵢ which is encoded within the example text prompt 302 shown in FIG. 3. The LLM 110 interprets the state string σ̅ᵢ (represented by the substring “x=12, y=13”) and produces \hat{σ}ᵢ=α_{C}(σ̅ᵢ), which corresponds to an unobservable internal state of the LLM 110. Further, the functional Λ_{\hat{q}} is an unknown functional that computes the abstract query \hat{q}, specified by the query string q̅=“Solve for z=x+y.”

In this example, the LLM output 304 for prompt 302 is “The value of z is 25”, and this is represented by the state string σ̅ᵢ₊₁. For concretization map, the concretization function γ_{c} interprets the text state σᵢ₊₁ as a concrete state {x→12, y→13, z→25} which is equal to the ground truth concrete state σᵢ₊₁. This relies on the LLM 110 computing the correct answer, which means that the corresponding diagram 200 for this example is commutative (and consequently, there is alignment). This example has a unique and precise solution, so the system 100 can easily check that the associated diagram 200 commutes. However, as in other examples below, this is not always the case.

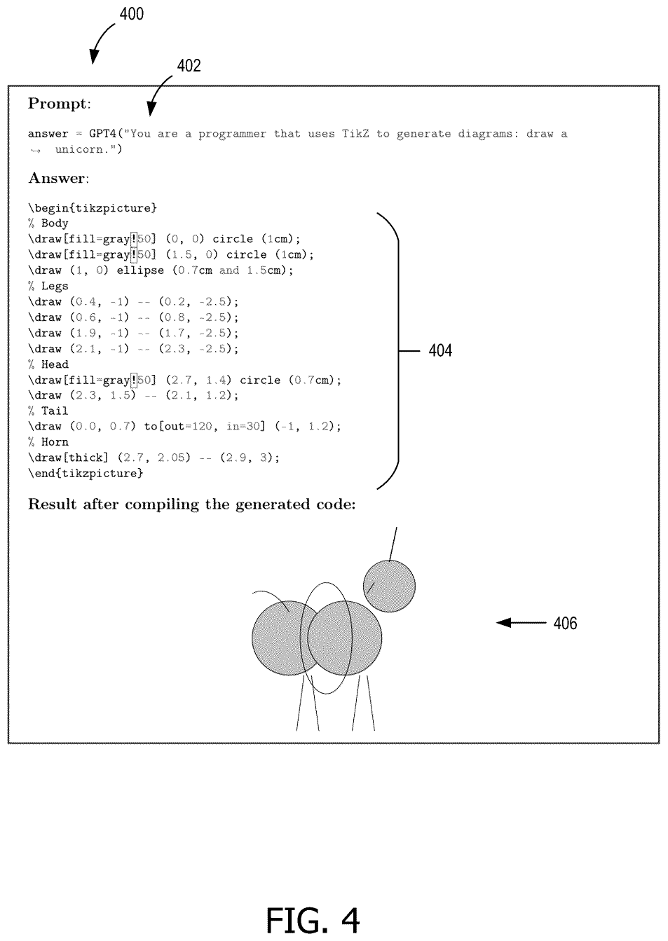

FIG. 4 illustrates another example prompt 402 and associated LLM output 404 for another example problem 400. In this example, the prompt 402 is a programming problem: “You are a programmer that uses TikZ to generate diagrams: draw a unicorn.” As such, the problem 400 is to write TikZ code (e.g., the LLM output 404) to draw a unicorn (e.g., shown as the result after compiling the generated code, as output 406). As such, the system 100 defines an instance of this problem 400 as follows.

For concrete state, the set of variables V={x, body, legs, head, tail, horn, m} is defined and represents the information needed to draw an animal using TikZ, which is a language for creating graphics in LaTeX. The variable x holds the name of the animal we want to draw (string value), such as unicorn, and the variables body, legs, head, tail, and horn hold the TikZ code for drawing each part of the animal, such as a circle, a line, or a curve. The variable m is a slack variable that can be used to store any additional information or code that is not captured by the other variables. The system 100 starts with an initial state σᵢ, where x is assigned the value “unicorn” and all the other variables are assigned the undefined value L, meaning that we do not have any code for drawing the unicorn yet.

In this example, the query 402, q, is a TikZ code generator that takes σᵢ as input, draws a diagram of σᵢ(x), and the problem is the pair (q, σᵢ). The functional Λ_{q}(σᵢ) computes the concrete output state σᵢ₊₁. In particular, σᵢ₊₁={x→“unicorn”, body→<code for body>, legs→<code for legs>, head→<code for head>, tail→<code for tail>, horn→code for horn, m→⊥}. This is the expected answer for the user 102 (e.g., the ground truth), which is defined as any code that sketches the unicorn. However, there are many possible ways to write such code. In examples, and as described in further detail below, the system 100 measures the quality of output 404, 406 provided by the LLM 110.

As an abstraction map, the function ac maps the concrete input state σᵢ to a state string σ̅ᵢ which is encoded within the example text prompt 402 shown in FIG. 4. The LLM 110 interprets the state string σ̅ᵢ (represented by the substring “unicorn”) and produces \hat{σ}ᵢ=α_{C}(σ̅ᵢ), which corresponds to an unobservable internal state of the LLM 110. Further, the functional Λ_{\hat{q}} is an unknown functional that takes the string q̅=“draw in TikZ” from the prompt and computes the abstract query \hat{q}.

In this example, the LLM output 404 for the prompt 402, as shown in FIG. 4, is “\begin {tikzpicture} . . . \end {tikzpicture}”, and this is represented by the state string σᵢ₊₁. For concretization map, the concretization function γ_{c} interprets the text state σ̅ᵢ₊₁ as a concrete state. In this example, the text state is a piece of code and, as such, may be compiled by the system 100 and may be displayed to the user 102 (e.g., showing either or both the code output 404 and the compiled output 406). In this example, the compiled code generates the shapes shown at the bottom of FIG. 4, which resembles a unicorn (e.g., as the output 406).

Unlike the arithmetic example 300 of FIG. 3, this example problem 400 has multiple solutions and the relation that makes the diagram 200 commute depends on the scenario. For example, different evaluation methods may have different standards, such as valuing how much the figure resembles a unicorn or valuing the clarity of the code.

The terms “hallucination” and “misalignment” are used to describe two common issues with LLMs. Hallucination means that LLMs produce wrong or irrelevant responses to prompts, but the output makes them sound reasonable or coherent. This can be dangerous when LLMs are used in critical domains where accuracy and safety are important. Alignment means that LLMs act in accordance with their human users' intentions. LLMs that are misaligned act differently from what their users want. This can also cause harm, such as giving wrong answers, generating biased outputs, or discriminating results. Alignment involves tuning LLMs to encourage desired behaviors and discourage undesired ones.

In this example, the system uses the diagram 200 and associated framework to represent hallucination and misalignment. Given a problem (q, σ), a compatibility relation ≡ is defined to compare the equivalence of two concrete states. Hallucination and misalignment occur when the diagram 200 for (q, σ) does not commute, meaning that the paths from σ to the output concrete state do not produce equivalent states under ≡. Formally, this means that the compatibility relationship (γ∘Λ_{\hat{q}}∘α)(σ)=Λ_{q}(σ), where (γ∘Λ_{\hat{q}}∘α)(σ) is the answer generated by the LLM 110, does not hold. The system 100 detects hallucinations or misalignments by comparing states, and thus a suitable notion of equivalence (≡) is defined that captures the types of errors of interest.

For example, consider the simple arithmetic problem 300 of FIG. 3, where the correct answer is {x→12, y→13, z→25, w→⊥}. If the LLM 110 outputs “The sum of x and y is 29”, this corresponds to the state {x→12, y→13, z→29, w→⊥} under the concretization function γ. This state is a hallucination because it does not match the correct answer (e.g., z=25). One possible way to define an equivalence relation is to compare the values of variables in two concrete states σ₁ and σ₂. As such, σ₁ and σ₂ are equivalent if they have the same value for every variable in V. Formally, (σ₁≡σ₂)⇐⇒∀x∈V. σ₁(x)=σ₂(x). According to this definition, the only state equivalent to {x→12, y→13, z→29, w→⊥} is itself.

However, suppose the LLM 110 outputs “The sum of x and y is a tiger”. This answer is both wrong and misaligned because it contains a nonsensical output that is not an integer. In this case, the only way for the two states to be aligned is if every variable in the scope has an integer value. That is, (σ₁≡σ₂)⇐⇒∀x∈V.typeof(σ₁(x))=typeof(σ₂(x))=int.

To evaluate how well the LLM 110 performs a task, the system 100 measures the extent of its hallucinations or misalignments. For example, given a problem (q, σ), the output of an LLM 110 is defined by the state string σ̅=(γₐ∘Λ_{\hat{q}}∘α)(σ). Applying the γ_{c} function to σ̅ results in the concrete state γ_{c}(σ̅). The compatibility relationship discussed above is used to determine whether the diagram 200 for (q, σ) is commutative. If it is not, a natural question to ask is how much the answer provided by the LLM 110 deviates from the one that would make the diagram 200 commutative.

As such, the system 100 evaluates how well the LLM 110 solves a problem by comparing its output state, σ, with a reference state that represents the correct answer, Λ_{q}(σ). To do this, the system 100 computes a distance metric Δ: 2^{V→C}×2^{V→C}→ [symbol] ⁺ that quantifies how different two states are. The choice of A depends on the problem scenario, but it must satisfy a consistency condition: the diagram 200 must commute, meaning that the concrete state derived from the output of the LLM, γ_{c}(σ̅), must have zero distance from the reference ground truth state, Λ_{q}(σ).

For example, suppose the system 100 is solving the problem of adding 12+13. If the output of the LLM 110 is σ and the system 100 applies γ_{c} to it, the system 100 generates γ_{c}(σ̅)=(12,13,19)^{T} (e.g., as a vectorized state). This is the concrete state that represents the answer provided by the LLM 110. However, the correct answer is 25, which can be determined by applying Λ_{q} to the input σ. This yields the reference ground truth state Λ_{q}(σ)=(12,13,25)^{T}. To measure how far the answer provided by the LLM 110 is from the correct answer, the system 100 uses the L1-norm as the distance function to get Δ(γ_{c}(σ̅), Λ_{q}(σ))=|19−25|=6. This means that the answer provided by the LLM 110 is off by 6 units. As such, the diagram 200 does not commute in this case, because γ_{c}(σ̅)≠Λ_{q}(σ).

Some problems need complex distance methods to measure how close the diagram 200 is to being commutative. This is more difficult when there are many valid solutions for the ground truth Λ_{q}(σ), such as in code generation where different solutions are acceptable. In examples, the user 102 of the LLM 110 may define these metrics to capture the right properties for these problems.

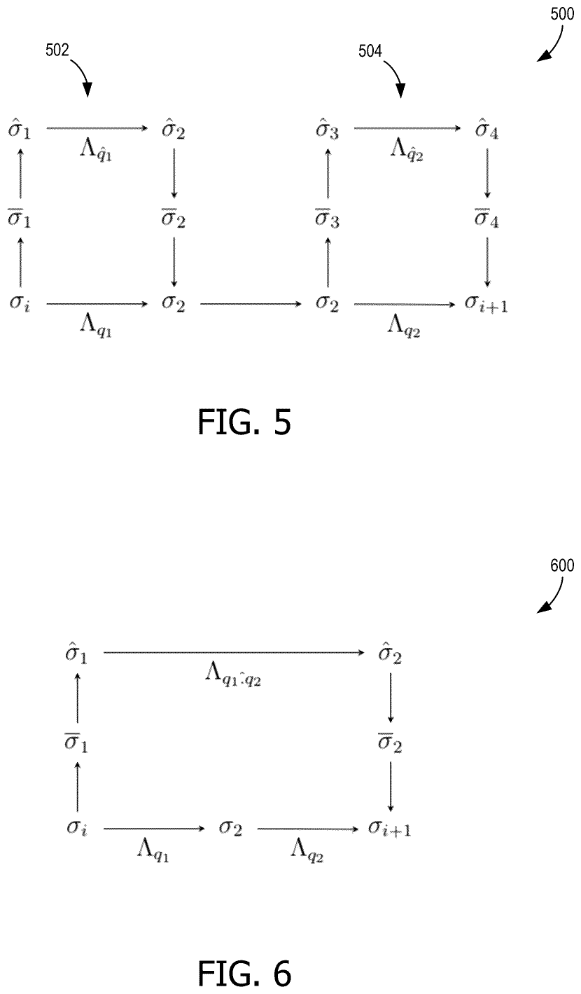

FIG. 5 and FIG. 6 illustrate diagrams 500, 600 that the LLM analytics device 120 creates to apply chain-of-thought (CoT) reasoning to prompts 106 for the LLM 110. In some examples, the diagrams 500, 600 may be similar to the diagram 200 shown in FIG. 2. In examples, the LLM analytics device 120 applies a CoT-based method for improving the ability of the LLM 110 to perform various reasoning tasks, such as answering questions, solving math problems, or generating explanations. Some problems are too complex or abstract for the LLM 110 to reliably solve directly. For example, direct application of the input prompt 106A to the LLM 110 can result in LLM output 112 having hallucinations 114, misalignments 116, or other such erroneous output, as shown in FIG. 1. Application of the prompt 106B to the LLM 110 benefits from breaking down the prompt 106B into simpler or more concrete sub-problems (e.g., via intermediate prompts 130).

In examples, the method involves prompting the LLM 110 to generate intermediate steps that lead to the final answer, and using these steps as additional context or feedback for the next step. More specifically, the input prompt 106B is transmitted to the LLM analytics device 120, and the LLM analytics device 120 interacts with the LLM 110 by sending one or more intermediate prompts 130 to the LLM 110 and receiving an intermediate output 132 in response, before generating a final output, or “curated output” 134 that is sent to the user computing device 104. This curated output 134 represents an output that is improved over what would be directly generated by the LLM 110 given the same input prompt 106 (e.g., a decrease in hallucinations 114, misalignments 116, or other errors, as compared to the LLM output 112 that would be generated by application of the input prompt 106A to the LLM 110 directly).

The diagram 500 in FIG. 5 illustrates CoT reasoning for two sub-problems 502, 504. In this example, consider the problem of drawing a hexagon with a circle inside it, and a square inside the circle. In CoT reasoning, the steps include (i) drawing a hexagon; (ii) drawing a circle inside the hexagon; and (iii) drawing a square inside the circle. This example CoT reasoning method helps the LLM 110 to avoid errors, gaps, or inconsistencies in its reasoning, and to produce more coherent and transparent outputs.

In this example, to formalize CoT reasoning, the LLM analytics device 120 creates diagram 500. Consider a problem (q, σᵢ), where q is a query (e.g., the input query 106B) and σᵢ is a concrete input state. The LLM analytics device 120 splits this problem into two sub-problems 502 (q₁, σ₁) and 504 (q₂, σ₂), such that the query transformation Λ_{q} is the same as applying Λ_{q}_{₁} first and then Λ_{q}_{₂}, with σᵢ=σ₁ and σ₂=Λ_{q}(σ₁). In other words, Λ_{q}(σᵢ)=(Λ_{q}_{₂}∘Λ_{q}_{₁})(σᵢ), where σᵢ=σ₁.

In a first example lemma, suppose a problem (q, σᵢ) can be solved by splitting it into two sub-problems (q₁, σ₁) and (q₂, σ₂), such that Λ(σᵢ)=(Λ_{q}_{₂}∘Λ_{q}_{₁})(σᵢ). Suppose also that FIG. 5 shows how to use the CoT reasoning method to solve (q, σ₁). As such, the CoT reasoning is valid if and only if every possible way of transforming σ₁ into Λ_{q}(σᵢ) in the diagram gives the same result (e.g., the diagram 500 commutes). Further, as proof, it follows from that fact that commutativity implies no hallucination 114 or misalignment 116.

To elicit CoT reasoning, CoT prompting embeds it in the prompt sent to the LLM 110 (e.g., via intermediate prompt(s) 130). This method is convenient because it avoids extra calls to the LLM 110, which can be costly. In the diagram 600 shown in FIG. 6, CoT prompting is illustrated. In this example, the LLM analytics device 120 splits the problem (q, σᵢ) into two sub problems (q₁, σ₁) and (q₂, σ₂), such that Λ_{q}=Λ_{q}_{₁}∘Λ_{q}_{₂}. In other words, CoT reasoning holds for the concrete problem. Let (q₁, _) and (q₂, _) be the prompts for the problems (q₁, σ₁) and (q₂, σ₂), respectively. The LLM analytics device 120 concatenates the query strings of the subproblem prompts to form the CoT prompt for the original problem: (q̅₁·q̅₂, σ₁). The abstract query corresponding to the CoT prompt is denoted by q₁\hat{·}q₂, and the LLM function that takes the CoT prompt as input and produces the text state q̅₂ as the output by Λ_{q}_{₁}\hat{·}_{q}_{₂}. As such, the following second lemma holds.

In an example second lemma, suppose a problem (q, σ₁) can be solved by splitting it into two sub-problems (q₁, σ₁) and (q₂, σ₂), such that Λ(σᵢ)=(Λ_{q}_{₂}∘Λ_{q}_{₁})(σᵢ). Suppose also that FIG. 6 shows how to use the CoT prompting method to solve (q, σ₁). As such, CoT prompting is valid if and only if every possible way of transforming σ₁ into Λ_{q}(σᵢ) in the diagram gives the same result (e.g., the diagram 600 commutes).

Consider as a corollary, CoT prompting and CoT reasoning produce the same output for a problem (q, σ) if and only if both of the following conditions are true: (i) CoT reasoning holds for the problem (q, σ) (that is, Λ_{q}=Λ_{q}_{₁}∘Λ_{q}_{₂}); and (ii) the diagrams 500, 600 for CoT reasoning and CoT prompting, respectively, are both commutative.

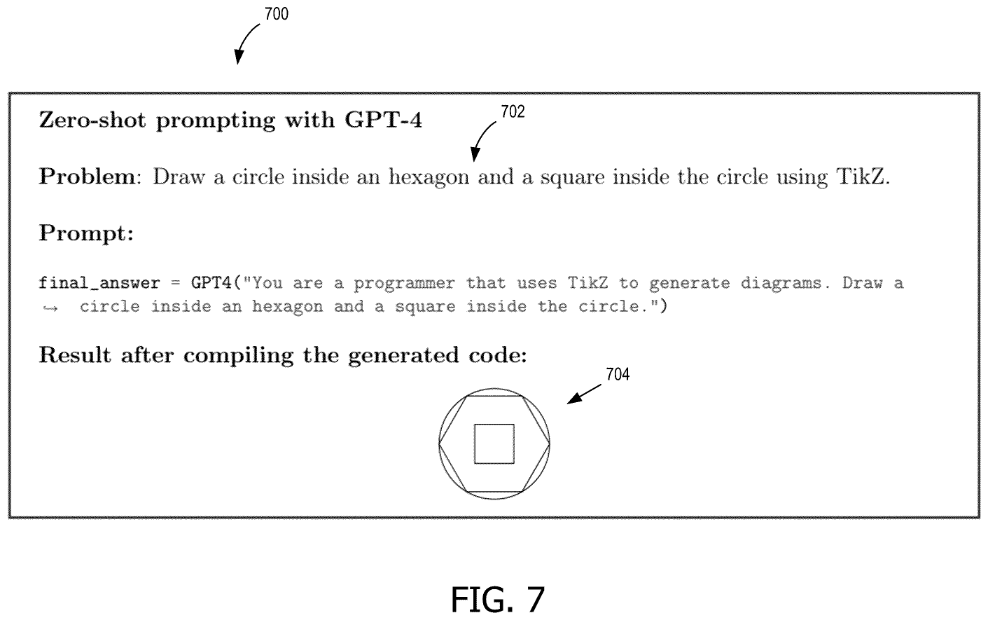

CoT prompting and CoT reasoning are equivalent only under the conditions given by this corollary. However, many known systems (including engineering APIs) rely on CoT prompting without verifying this. This can lead to incorrect outcomes. Typically, CoT prompting may not be sufficient for enabling CoT reasoning. FIG. 7 illustrates an example zero-shot prompting task 700 for a problem 702: generate TikZ code to draw a circle inside a hexagon, and a square inside the circle. However, when presented directly to the LLM 110 (e.g., GPT4 in the example) as prompt 106A, the resultant code (not shown) yields an incorrect result 704. More specifically, the results after compiling the generated code show a hexagon inside a circle and a square inside the hexagon.

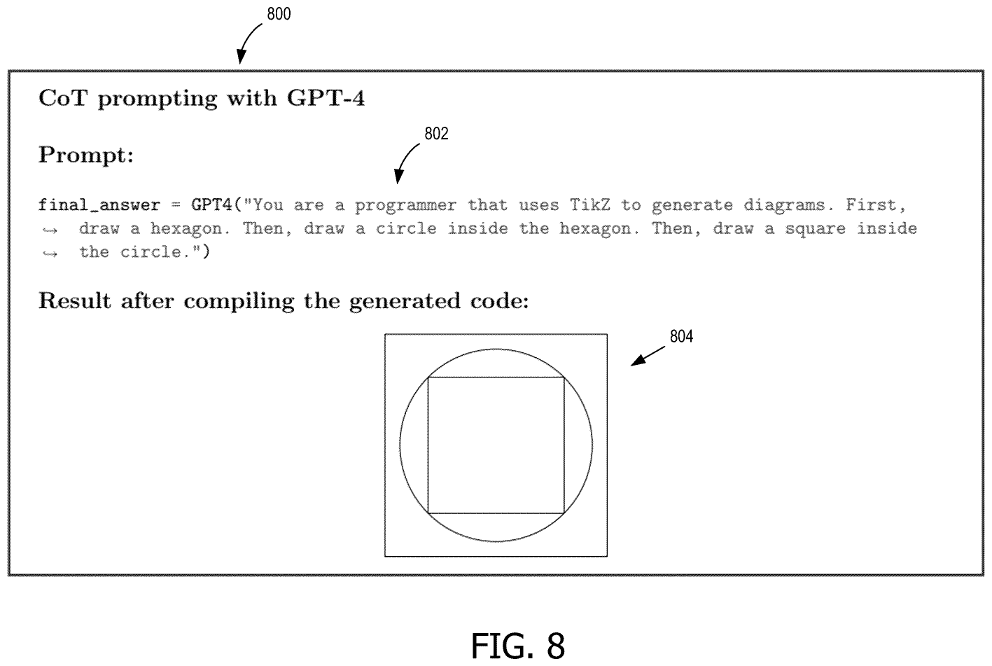

FIG. 8 illustrates another example 800 in which CoT prompting is used with the LLM 110. In this example, a prompt 802 is provided as: “You are a programmer that uses TikZ to generate diagrams. First, draw a hexagon. Then, draw a circle inside the hexagon. Then, draw a square inside the circle.” With CoT prompting, or trying to solve the problem step by step in the same prompt, the code generated by the LLM 110 draws a circle inside a square, and another square inside the circle, as shown by the result 804 in FIG. 8. Unfortunately, this is still incorrect and in fact, worse than the zero-shot instance shown in FIG. 7, which did not draw an incorrect shape (e.g., a square instead of a hexagon).

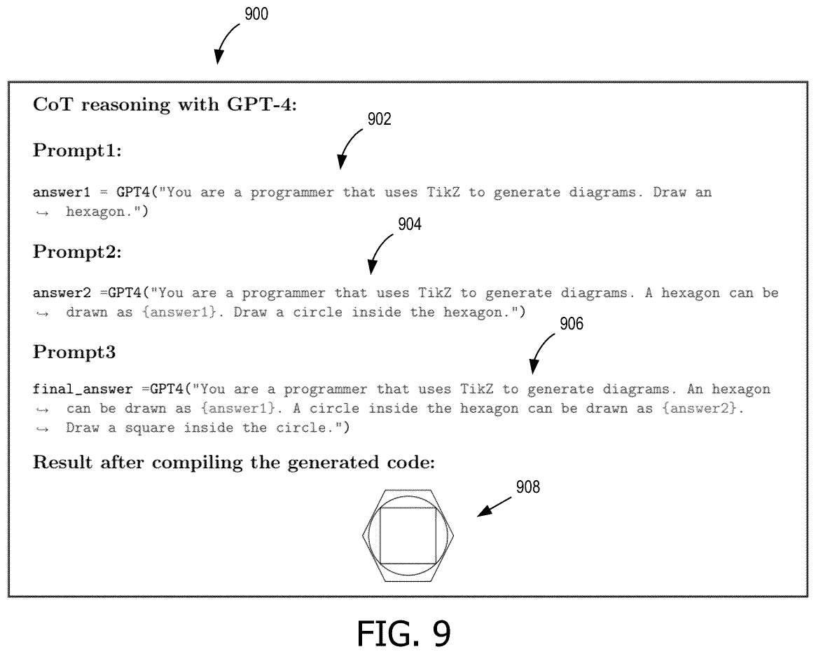

FIG. 9 illustrates another example 900 in which the LLM analytics device 120 uses CoT reasoning with the LLM 110 to draw the correct figure using several intermediate prompts 130 and evaluating several intermediate outputs 132. More specifically, in this example, the LLM analytics device 120 receives an initial prompt (e.g., the input prompt 106B of FIG. 1) as shown in FIG. 7, namely “You are a programmer that uses TikZ to generate diagrams. Draw a circle inside a hexagon and a square inside the circle.” The LLM analytics device 120 divides the problem into several sub-problems and associated prompts 902, 904, 906 (e.g., intermediate prompts 130).

In this example, the first prompt 902 submitted to the LLM 110 is “Prompt1”, namely “You are a programmer that uses TikZ to generate diagrams. Draw a hexagon.” In response, the LLM 110 generates TikZ code (not shown) that results in first intermediate output 132, identified in FIG. 9 as ‘{answer1}’ (presumably code that would result in the display of a hexagon when compiled). The LLM analytics device 120 then uses the results of the first prompt 902 (e.g., ‘{answer1}’) to create and submit a second prompt 904 to the LLM 110 as “Prompt2”, namely “You are a programmer that uses TikZ to generate diagrams. A hexagon can be drawn as {answer1}. Draw a circle inside the hexagon.” In response, the LLM 110 generates updated code (not shown) that results in second intermediate output 132, identified in FIG. 9 as ‘{answer2}’ (presumably code that would result in the display of a circle inside of a hexagon when compiled).

In this example, the LLM analytics device 120 then uses the first and second intermediate outputs 132 from the prompts 902, 904 (e.g., ‘{answer1}’ and ‘{answer2}’) to create and submit a third prompt 906 to the LLM 110 as “Prompt3”, namely “You are a programmer that uses TikZ to generate diagrams. A hexagon can be drawn as {answer1}. A circle inside the hexagon can be drawn as {answer2}. Draw a square inside the circle.” In response, the LLM 110 generates the figure shown at the bottom of FIG. 9, namely a square inside a circle that is inside a hexagon. This third and final intermediate output 132 is the proper output (e.g., shown as output 908) that is provided to the user computing device 104 as the curated output 134 (shown in FIG. 1).

In examples, subsequent intermediate prompts 130 (e.g., prompts 904, 906) can identify, reference, or otherwise include one or more intermediate outputs 132 generated by prior intermediate prompts 130 (e.g., prompts 902, 904). For purposes of illustration, the example shown in FIG. 9 uses a reference identifier for the prior intermediate output(s) used by the prompts 904, 906. In some examples, the actual intermediate output(s) 132 may be expressly recited in the subsequent prompt(s) 130 to similar effect.

In examples, the initial input prompt 106B is parsed into a plurality of intermediary steps. For example, presume that the initial input prompt 106B of the example in FIG. 9 is similar to the problem 802 of FIG. 8: “You are a programmer that uses TikZ to generate diagrams. First, draw a hexagon. Then, draw a circle inside the hexagon. Then, draw a square inside the circle.” In some examples, the LLM analytics device 120 identifies that there are multiple sentences or compound sentence(s) within the initial input prompt 106B and breaks those sentences into the multiple intermediate prompts 130 based on, for example, an order to the sentences (e.g., in the order they appear in the initial input prompt 106B), or via sequence adverbs or temporal adverbs (e.g., ‘first’, ‘second’, ‘then’, ‘next’, ‘after that’, ‘finally’). Further, the LLM analytics device 120 may also identify some of text of the initial input prompt 106B as contextual text (e.g., as text that is not a part of any of the separate instructions). For example, the text “You are a programmer that uses TikZ to generate diagrams” is not included in any of the instructions. As such, this contextual text may be included in any or all of the intermediate input prompts 130, such as the prompts 902-906 of FIG. 9.

In this example, while parsing this example initial input prompt 106B, the LLM analytics device 120 identifies the sentence “First, draw a hexagon” as the first step or instruction (e.g., based on the temporal adverb ‘first’), and thus generates the first prompt 902 as “<Contextual text>.<Instruction 1>”, where <Contextual text> in these examples is “You are a programmer that uses TikZ to generate diagrams”, and where <Instruction 1> is “Draw a hexagon” (e.g., from the sentence of the initial input prompt 106B, “First, draw a hexagon”, with the temporal adverb being removed). As such, the first prompt 902 is created as “You are a programmer that uses TikZ to generate diagrams. Draw a hexagon.” When applied to the LLM 110, this first prompt 902 generates an intermediate output 132 (not shown) that can subsequently be referenced as ‘{answer1}’ in subsequent intermediate prompts 130.

Likewise, for the second prompt 904, the LLM analytics device 120 identifies a second step or instruction from the next sentence of the initial input prompt 106B (e.g., “Then, draw a circle within the hexagon” as <Instruction 2>). From this second instruction, the second prompt 904 is created as “<Contextual text>.<Intermediate Output 1>.<Instruction 2>”, where <Intermediate Output 1> is an inclusion or reference to the prior intermediate output 132 (e.g., the ‘{answer1}’ generated by the first prompt 902, shown here as the sentence “A hexagon can be drawn as {answer1}”), and where <Instruction 2> is “Draw a circle inside the hexagon”. As such, the second prompt 904 is created as “You are a programmer that uses TikZ to generate diagrams. A hexagon can be drawn as {answer1}. Draw a circle inside the hexagon.” Similarly, when applied to the LLM 110, this second prompt 904 generates an intermediate output 132 (not shown) that can subsequently be referenced as ‘{answer2}’ in subsequent intermediate prompts 130.

For the third prompt 906, the LLM analytics device 120 identifies a third step or instruction from the next sentence of the initial input prompt 106B (e.g., “Then, draw a square inside the circle” as <Instruction 3>). From this third instruction, the third prompt 906 is created as “<Contextual text>.<Intermediate Output 1>.<Intermediate Output 2>.<Instruction 3>”, where <Intermediate Output 1> is an inclusion or reference to {answer1} generated by the first prompt 902, <Intermediate Output 2> is an inclusion or reference to {answer2} generated by the second prompt 904, and where <Instruction 3> is “Draw a square inside the circle”. As such, the third prompt 906 is created as “You are a programmer that uses TikZ to generate diagrams. A hexagon can be drawn as {answer1}. A circle inside the hexagon can be drawn as {answer2}. Draw a square inside the circle.” Similarly, when applied to the LLM 110, this third prompt 904 generates an intermediate output 132 (shown as output 908), which can finally be provided as curated output 134.

In some examples, parsing the initial input prompt 106B can include identifying multiple steps based on one or more pre-configured templates based on matching a syntactic form of the initial input prompt 106B. For example, presume a template is defined as: “<*A*>.< [First], *B*>.< [Second, Next, Then], *C*>.< [Third, Next, Then, Finally], *D*>”. Such a template can be applied to the example initial input prompt 106B as described above based on the adverbs ‘first’, ‘next’, and ‘then’. As such, *A* is assigned to the contextual text “You are a programmer that uses TikZ to generate diagrams”, *B* is identified as the first step, *C* is identified as the second step, and *D* is identified as the third step. As such, the LLM analytics device 120 can use such a template to parse the initial input prompt 106B into multiple sub-steps, and thus to similarly generate the prompts 902, 904, 906.

In some examples, parsing the initial input prompt 106B can include using the LLM 110 to parse the initial input prompt 106B. More specifically, the LLM analytics device 120 can create a ‘deconstruction LLM prompt’ that is used to parse (or ‘deconstruct’) the initial input prompt 106B into multiple steps through the help of the LLM 110. For example, the LLM 110 can be asked to identify the multiple steps of the initial input prompt 106B by creating and submitting a deconstruction LLM prompt as: “Identify each individual step in the following LLM prompt: ‘<Initial Input Prompt>’”, where <Initial Input Prompt> is the source text of the initial input prompt 106B. As such, in the above example, the LLM 110 identifies three individual steps as “1. Draw a Hexagon. 2. Draw a circle inside the hexagon. 3. Draw a square inside the circle.” Accordingly, the LLM analytics device 120 may initially submit this deconstruction LLM prompt (as a first intermediate prompt 130) and analyze the output to identify the instructions identified by the LLM 110 (e.g., identifying the three steps from a parsing of the output). As such, and similar to the above examples, once the three steps have been identified, the LLM analytics device 120 uses those three steps to generate the prompts 902, 904, 906, similarly submitting each intermediate prompt 130 in the identified order, and subsequently submitting the prior results to the next intermediate prompt 130 until the output 908 has been generated.

The above corollary has important consequences on concepts in the LLM space. These include self-verification and prompt engineering. Self-verification is the ability of the LLM 110 to assess the validity of their own output. In problems solved with self-verification, the same LLM 110 plays two different roles: (1) the LLM 110 is a generator of solutions, and (2) the LLM 110 is a discriminator of potentially wrong answers.

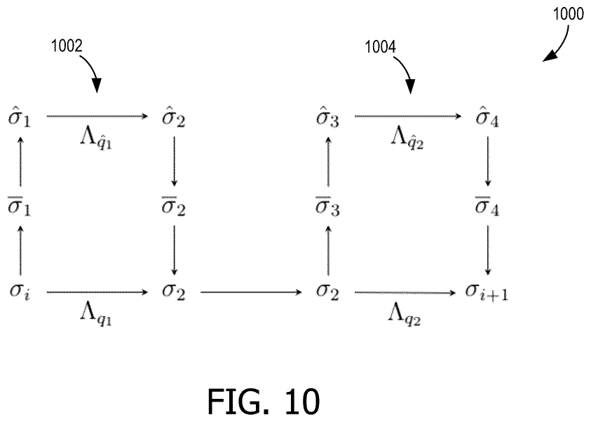

FIG. 10 is an example diagram 1000 that illustrates self-verification under an example framework. In this example, the system 100 performs self-verification as two sub-problems 1002, 1004. The first sub-problem 1002 is a problem (q₁, σ₁) that generates an output state σ₂=Λ_{q}_{₁}(σ1). The second sub-problem 1004 is a verification problem (q₂, σ₂) that takes σ₂ as input and produces a state σ₃ that indicates whether σ₂ is correct or not. This process can be represented by composing the diagram 1000 for the two sub-problems (q₁, σ₁) and (q₂, σ₂). This is analogous to the CoT reasoning. Here, there is a theoretical justification for the empirical evidence that self-verification improves accuracy, namely a commutative diagram, like the diagram 1000 of FIG. 10, where the two sub-diagrams are the generation and verification steps.

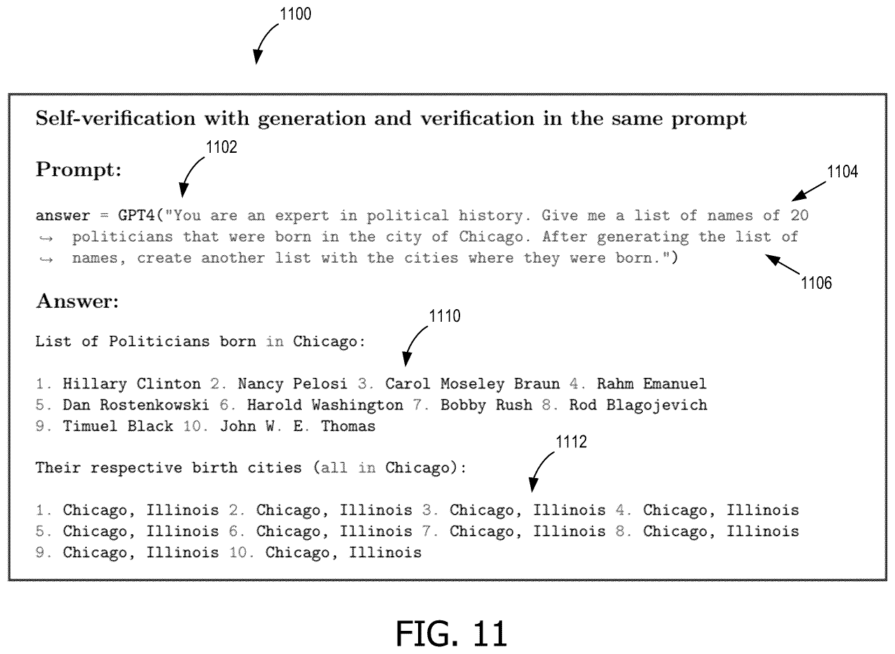

FIG. 11 provides an example illustration 1100 of self-verification with generation and verification in the same prompt 1102. In this example, a generation step 1104 and a verification step 1106 are combined in the same prompt (e.g., as a direct prompt 106A to the LLM 110). More specifically, the example prompt 1102 is: “You are an expert in political history. Give me a list of names of 20 politicians that were born in the city of Chicago. After generating the list of names, create another list with the cities where they were born.”

During the generation step, the LLM 110 produces a list of 10 names (represented here as output 1110), but it has no way of asserting if they were all born in Chicago (e.g., there could be hallucinations 114 or misalignments 116 in this output 1110). In fact, Nancy Pelosi, Bobby Rush and Timuel Black were born elsewhere, but in this example, the LLM 110 identifies all of them as having been born in Chicago (e.g., as also shown with errors in output 1112). However, if verification were split into two steps (e.g., generating the list and then verifying the list), the LLM analytics device 120 can use the LLM 110 to identify mistakes.

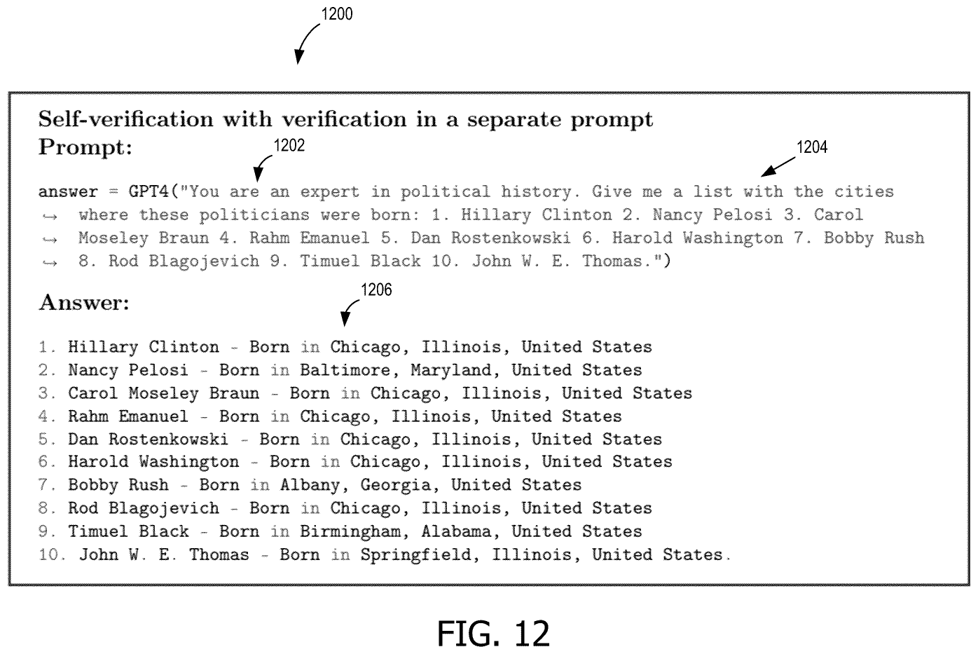

FIG. 12 illustrates a verification step performed based on the output of the example shown in FIG. 11. Splitting the problem of prompt 1102 into several intermediate prompts 130, rather than one unified prompt, helps in this example. More specifically, the prompt 1102 is provided as the initial input prompt 106B, causing the LLM analytics device 120 to identify the text “You are an expert in political history” as contextual text, as well as identifying the first step 1104 as “Give me a list of names of 20 politicians that were born in the city of Chicago” and the second step 1106 as “After generating the list of names, create another list with the cities where they were born.” Accordingly, upon submitting the first step 1104, the LLM 110 generates the output 1110 of FIG. 11 (e.g., as a first intermediate output 132).

To verify this output, the LLM analytics device 120 creates and submits a verification LLM prompt 1202 as shown in FIG. 12, namely “You are an expert in political history. Give me a list of cities where these politicians were born: 1. Hillary Clinton 2. Nancy Pelosi 3. Carol Mosely Braun 4. Rahm Emanuel 5. Dan Rostenkowski 6. Harold Washington 7. Bobby Rush 8. Rod Blagojevich 9. Timuel Black 10. John W. E. Thomas.” This verification LLM prompt 1202 is created with a list of specific entries generated by the ‘{answer1}’ output of the first intermediate output 132, namely the list of politicians that are allegedly born in Chicago, based on the output 1110. Upon submission of this second intermediate prompt 130, the LLM 110 generates the output 1206. This output 1206 may then be parsed and compared to the output 1112, thereby allowing the LLM analytics device 120 to identify any inaccuracies (e.g., hallucinations 114) appearing between the two outputs 1112, 1206.

Generating and verifying answers may involve multiple sub-problems, each of which could benefit from CoT reasoning. CoT reasoning could also help to decompose the generation and verification processes further, when they require multiple steps. Further, the text structure of a prompt can affect how LLMs process and respond to it.

A clear and concise prompt has two basic components: a query and a state. The query tells the LLM 110 what the user 102 wants to do, such as summarize a text or caption an image. The state provides the LLM 110 with the data or information it needs to do it, such as the text or the image. This separation makes it easier to design prompts that can adapt to different scenarios.

As used herein, an API to a general purpose trainer provides a natural way to separate the query and the state in the prompt. The API lets users structure the prompt into three sections: “system”, “user”, and “assistant”. These sections correspond to the key elements of the diagram 200 of FIG. 2. More specifically, the “system” section defines the role of the LLM 110. It is the query component of the prompt, q̅, that expresses the question q that the user 102 wants to answer. The “user” section provides the specifics of the question. It is the state component of the prompt, σ̅ᵢ, that represents the textual version of the initial state σᵢ. The “assistant” section allows the user to write the state σ̅ᵢ₊₁ explicitly. This is useful for few-shot learning approaches, where multiple pairs of prompts and responses are given to the LLMs before the final question is asked.

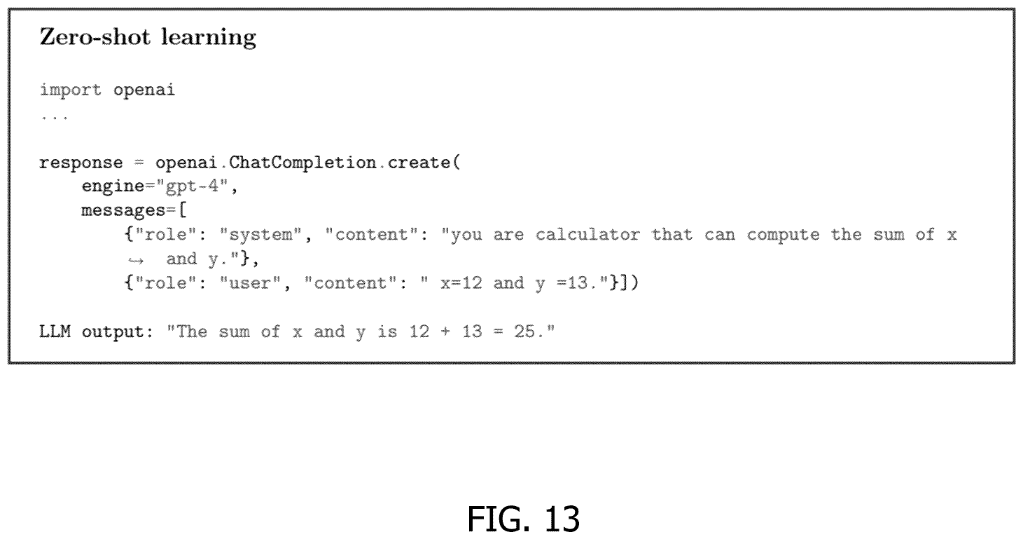

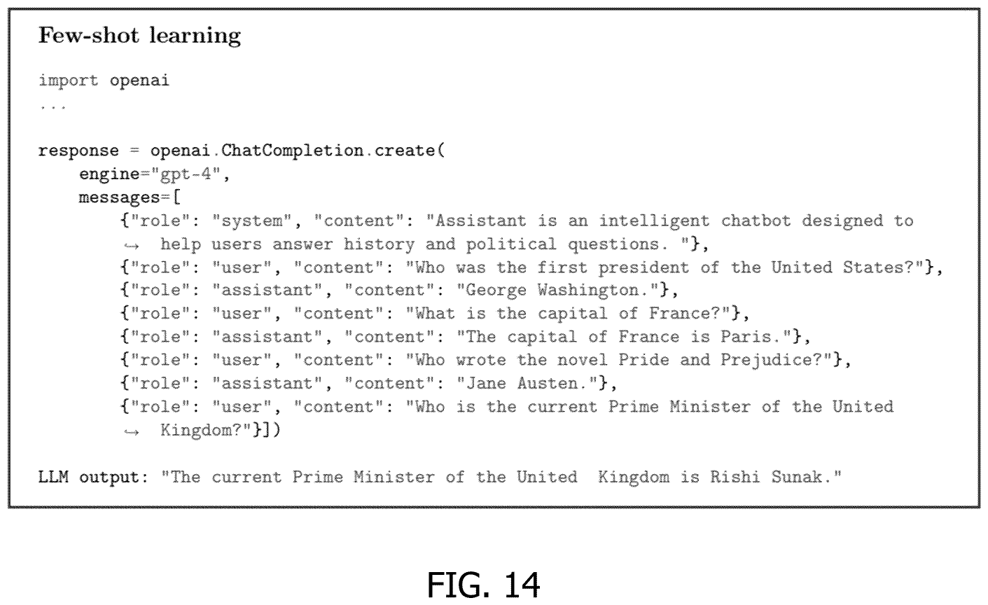

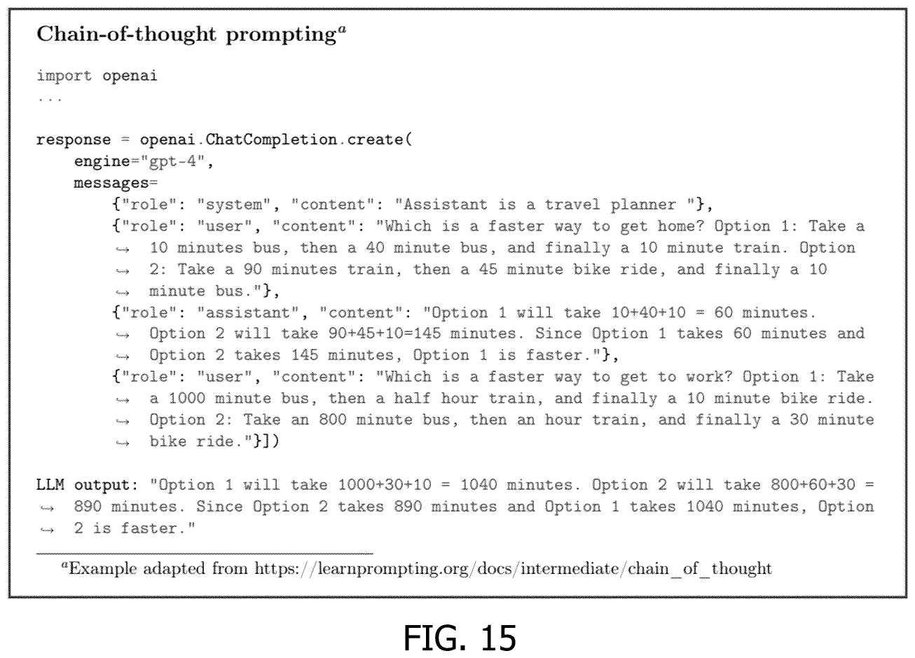

FIG. 13 illustrates an example of using the Python API to write a zero-shot prompt for adding two numbers. This example is similar to the example shown in FIG. 3. FIG. 14 illustrates another example in which the same API also supports few-shot learning, which uses some examples of questions and answers that are related to the query. FIG. 15 illustrates an example of using the same API to create CoT prompts by providing the assistant with step-by-step solutions of the examples as its input.

This API gives the user flexibility to structure the problem and assign different roles to the parts of the prompt. However, it does not show how the service combines these components internally. As explained herein, CoT reasoning involves strong assumptions and multiple calls to the LLM 110 (e.g., one for each step), unlike CoT prompting that uses a single prompt. This enables more diverse and effective ways to use and deploy LLMs 110 like GPT-4 with CoT reasoning ideas. This is especially helpful in domains like healthcare, where a domain expert needs to define and execute sub-tasks of a problem.

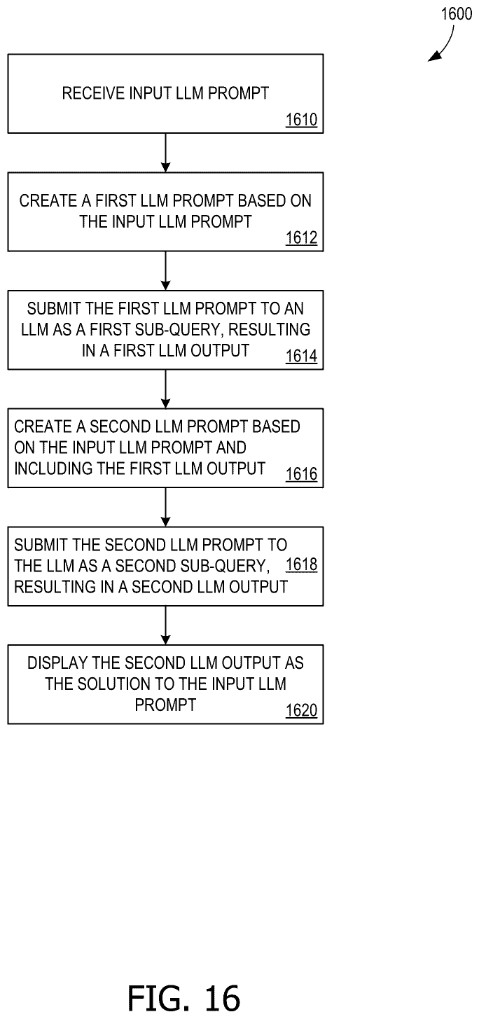

FIG. 16 is a flowchart illustrating an example computer-implemented method 1600. In some examples, the method 1600 may be performed by the LLM analytics device 120 and/or the user computing device 104 using the LLM 110 shown in FIG. 1. In the example, the LLM analytics device 120 receives an input large language model (LLM) prompt (e.g., prompt 106B, as example prompt 802) at operation 1610. At operation 1612, the LLM analytics device 120 creates a first LLM prompt (e.g., prompt 902) based on the input LLM prompt, the first LLM prompt representing a first step toward generating a first solution (e.g., output 908, as curated output 134) to the input LLM prompt. At operation 1614, the LLM analytics device 120 submits the first LLM prompt to an LLM (e.g., LLM 110) as a first sub-query (e.g., submitted as an intermediate prompt 130), thereby resulting in the generation of a first LLM output (e.g., ‘{answer1}’ of FIG. 9, received as intermediate output 132).

At operation 1616, the LLM analytics device 120 creates a second LLM prompt (e.g., prompt 904) based on the input LLM prompt, the second LLM prompt representing a second step toward generating the first solution to the input LLM prompt, the second LLM prompt including the first LLM output (e.g., ‘{answer1}’ of the FIG. 9 example). At operation 1618, the LLM analytics device 120 submits the second LLM prompt to the LLM 110 as a second sub-query, thereby resulting in the generation of a second LLM output (e.g., ‘{answer2}’ of the FIG. 9 example). At operation 1620, the LLM analytics device displays the second LLM output as the first solution to the input LLM prompt in response to the receiving of the input LLM prompt.

In some examples, the input LLM prompt includes a first sentence and a second sentence, wherein creating the first LLM prompt comprises creating the first LLM prompt to include at least the first sentence, wherein creating the second LLM prompt comprises creating the first LLM prompt to include at least the second sentence. In some examples, the LLM analytics device 120 also parses the input LLM prompt based on one or more of sequence adverbs and temporal adverbs, wherein creating the first LLM prompt further comprises removing at least one adverb from the first sentence. In some examples, the LLM analytics device 120 also identifies a pre-configured template that matches a form of the input LLM prompt, wherein creating the first LLM prompt comprises creating the first LLM prompt based on matching one or more portions of the input LLM prompt to one or more portions of the pre-configured template.

In some examples, the LLM analytics device 120 also creates a deconstruction LLM prompt based on the input LLM prompt, the deconstruction LLM prompt being formed to query the LLM to identify multiple sub-steps from within input LLM prompt, and submits the deconstruction LLM prompt to the LLM, thereby generating a deconstruction LLM output that includes at least a first step and a second step, wherein creating the first LLM prompt based on the input LLM prompt further includes creating the first LLM prompt based on the first step, wherein creating the second LLM prompt based on the input LLM prompt further includes creating the second LLM prompt based on the second step.

In some examples, the LLM analytics device 120 also creates a verification LLM prompt based on the first LLM output, submits the verification LLM prompt to the LLM, thereby generating a verification LLM output, compares the verification LLM output to the first solution based on a comparison metric, and displays a result of the comparison.

In some examples, the LLM analytics device 120 also generates a graph that includes a first state node, a second state node, and one or more edges, the first state node representing an initial state of one or more variables identified by the input LLM prompt, the second state node representing a second state of the one or more variables, identifies a first edge connecting the first state node and the second state node, the first edge representing a trusted application of the input LLM query to the one or more variables, thereby resulting in a trusted solution, identifies one or more other edges connecting the first state node and the second state node, the one or more other edges representing application of the input LLM query via the LLM, thereby resulting in the first solution, and determines whether or not the graph commutes based on whether first solution matches the trusted solution.

### Additional Examples

An example system comprises: a processor; and a computer-readable medium storing instructions that are operative upon execution by the processor to: receive an input large language model (LLM) prompt; create a first LLM prompt based on the input LLM prompt, the first LLM prompt representing a first step toward generating a first solution to the input LLM prompt; submit the first LLM prompt to an LLM as a first sub-query, thereby resulting in the generation of a first LLM output; create a second LLM prompt based on the input LLM prompt, the second LLM prompt representing a second step toward generating the first solution to the input LLM prompt, the second LLM prompt including the first LLM output; submit the second LLM prompt to the LLM as a second sub-query, thereby resulting in the generation of a second LLM output; and cause the second LLM output to be displayed as the first solution to the input LLM prompt in response to the receiving of the input LLM prompt.

An example computer-implemented method comprises: receiving an input large language model (LLM) prompt; creating a first LLM prompt based on the input LLM prompt, the first LLM prompt representing a first step toward generating a first solution to the input LLM prompt; submitting the first LLM prompt to an LLM as a first sub-query, thereby resulting in the generation of a first LLM output; creating a second LLM prompt based on the input LLM prompt, the second LLM prompt representing a second step toward generating the first solution to the input LLM prompt, the second LLM prompt including the first LLM output; submitting the second LLM prompt to the LLM as a second sub-query, thereby resulting in the generation of a second LLM output; and displaying the second LLM output as the first solution to the input LLM prompt in response to the receiving of the input LLM prompt.

An example computer storage device has computer-executable instructions stored thereon, which, on execution by a computer, cause the computer to perform operations comprising: receiving an input large language model (LLM) prompt; creating a first LLM prompt based on the input LLM prompt, the first LLM prompt representing a first step toward generating a first solution to the input LLM prompt; submitting the first LLM prompt to an LLM as a first sub-query, thereby resulting in the generation of a first LLM output; creating a second LLM prompt based on the input LLM prompt, the second LLM prompt representing a second step toward generating the first solution to the input LLM prompt, the second LLM prompt including the first LLM output; submitting the second LLM prompt to the LLM as a second sub-query, thereby resulting in the generation of a second LLM output; and displaying the second LLM output as the first solution to the input LLM prompt in response to the receiving of the input LLM prompt.

Alternatively, or in addition to the other examples described herein, examples include any combination of the following:
receiving an input large language model (LLM) prompt;
creating a first LLM prompt based on the input LLM prompt;
an LLM prompt representing a first step toward generating a first solution to the input LLM prompt;
submitting the first LLM prompt to an LLM as a first sub-query, thereby resulting in the generation of a first LLM output;
submitting intermediate LLM prompts to an LLM;
receiving intermediate LLM outputs from an LLM;
creating a second LLM prompt based on the input LLM prompt, the second LLM prompt representing a second step toward generating the first solution to the input LLM prompt, the second LLM prompt including the first LLM output;
submitting the second LLM prompt to the LLM as a second sub-query, thereby resulting in the generation of a second LLM output;
displaying the second LLM output as the first solution to the input LLM prompt in response to the receiving of the input LLM prompt;
transmitting the second LLM output as query response output for the input LLM prompt;
causing LLM output to be displayed on a user computing device;
LLM prompt that includes a first sentence and a second sentence;
creating an LLM prompt comprises creating the first LLM prompt to include at least the first sentence;
creating an LLM prompt comprises creating the first LLM prompt to include at least the second sentence;
parsing the input LLM prompt based on one or more of sequence adverbs and temporal adverbs;
creating the first LLM prompt further comprises removing at least one adverb from the first sentence;
identifying a pre-configured template that matches a form of the input LLM prompt;
creating the first LLM prompt comprises creating the first LLM prompt based on matching one or more portions of the input LLM prompt to one or more portions of the pre-configured template;
creating a deconstruction LLM prompt based on the input LLM prompt;
a deconstruction LLM prompt being formed to query the LLM to identify multiple sub-steps from within input LLM prompt;
submitting a deconstruction LLM prompt to the LLM, thereby generating a deconstruction LLM output that includes at least a first step and a second step;
creating the first LLM prompt includes creating the first LLM prompt based on the first step;
creating an LLM prompt includes creating the second LLM prompt based on the second step;
creating a verification LLM prompt based on the first LLM output;
submitting the verification LLM prompt to the LLM, thereby generating a verification LLM output;
comparing the verification LLM output to the first solution based on a comparison metric;
displaying a result of the comparison;
generating a graph that includes a first state node, a second state node, and one or more edges, the first state node representing an initial state of one or more variables identified by the input LLM prompt, the second state node representing a second state of the one or more variables;
identifying a first edge connecting the first state node and the second state node, the first edge representing a trusted application of the input LLM query to the one or more variables, thereby resulting in a trusted solution;
identifying one or more other edges connecting the first state node and the second state node, the one or more other edges representing application of the input LLM query via the LLM, thereby resulting in the first solution; and
determining whether or not the graph commutes based on whether first solution matches the trusted solution.

While the aspects of the disclosure have been described in terms of various examples with their associated operations, a person skilled in the art would appreciate that a combination of operations from any number of different examples is also within scope of the aspects of the disclosure.

### Example Operating Environment

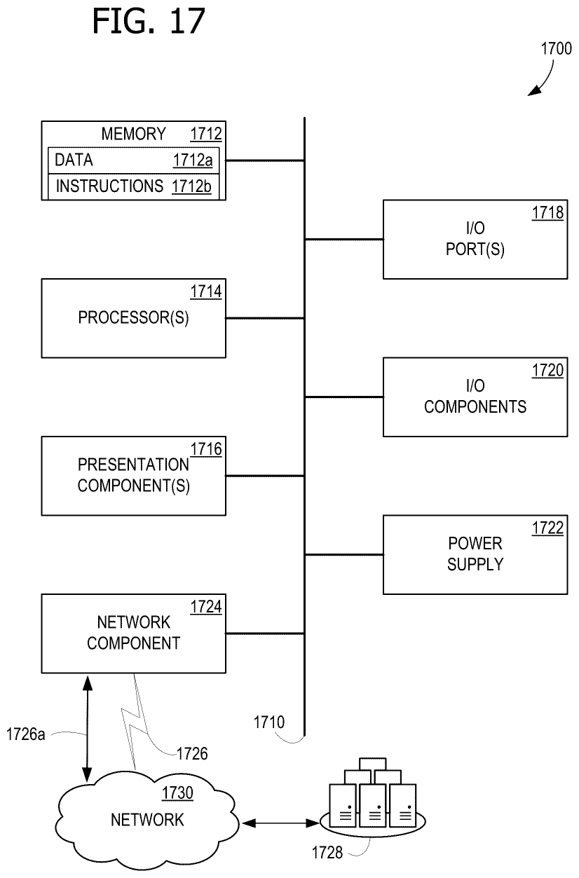

FIG. 17 is a block diagram of an example computing device 1700 (e.g., a computer storage device) for implementing aspects disclosed herein and is designated generally as computing device 1700. In some examples, one or more computing devices 1700 are provided for an on-premises computing solution. In some examples, one or more computing devices 1700 are provided as a cloud computing solution. In some examples, a combination of on-premises and cloud computing solutions are used. Computing device 1700 is but one example of a suitable computing environment and is not intended to suggest any limitation as to the scope of use or functionality of the examples disclosed herein, whether used singly or as part of a larger set. Neither should computing device 1700 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1700 includes a bus 1710 that directly or indirectly couples the following devices: computer storage memory 1712, one or more processors 1714, one or more presentation components 1716, input/output (I/O) ports 1718, I/O components 1720, a power supply 1722, and a network component 1724. While computing device 1700 is depicted as a seemingly single device, multiple computing devices 1700 may work together and share the depicted device resources. For example, memory 1712 may be distributed across multiple devices, and processor(s) 1714 may be housed with different devices.

Bus 1710 represents what may be one or more busses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 1712 may take the form of the computer storage media referenced below and operatively provide storage of computer-readable instructions, data structures, program modules and other data for the computing device 1700. In some examples, memory 1712 stores one or more of an operating system, a universal application platform, or other program modules and program data. Memory 1712 is thus able to store and access data 1712a and instructions 1712b that are executable by processor 1714 and configured to carry out the various operations disclosed herein.

In some examples, memory 1712 includes computer storage media. Memory 1712 may include any quantity of memory associated with or accessible by the computing device 1700. Memory 1712 may be internal to the computing device 1700 (as shown in FIG. 6), external to the computing device 1700 (not shown), or both (not shown). Additionally, or alternatively, the memory 1712 may be distributed across multiple computing devices 1700, for example, in a virtualized environment in which instruction processing is carried out on multiple computing devices 1700. For the purposes of this disclosure, “computer storage media,” “computer-storage memory,” “memory,” and “memory devices” are synonymous terms for the computer-storage memory 1712, and none of these terms include carrier waves or propagating signaling.

Processor(s) 1714 may include any quantity of processing units that read data from various entities, such as memory 1712 or I/O components 1720. Specifically, processor(s) 1714 are programmed to execute computer-executable instructions for implementing aspects of the disclosure. The instructions may be performed by the processor, by multiple processors within the computing device 1700, or by a processor external to the client computing device 1700. In some examples, the processor(s) 1714 are programmed to execute instructions such as those illustrated in the flow charts discussed below and depicted in the accompanying drawings. Moreover, in some examples, the processor(s) 1714 represent an implementation of analog techniques to perform the operations described herein. For example, the operations may be performed by an analog client computing device 1700 and/or a digital client computing device 1700. Presentation component(s) 1716 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1700, across a wired connection, or in other ways. I/O ports 1718 allow computing device 1700 to be logically coupled to other devices including I/O components 1720, some of which may be built in. Example I/O components 1720 include, for example but without limitation, a microphone, joystick, game pad, satellite dish, scanner, printer, wireless device, etc.

Computing device 1700 may operate in a networked environment via the network component 1724 using logical connections to one or more remote computers. In some examples, the network component 1724 includes a network interface card and/or computer-executable instructions (e.g., a driver) for operating the network interface card. Communication between the computing device 1700 and other devices may occur using any protocol or mechanism over any wired or wireless connection. In some examples, network component 1724 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1724 communicates over wireless communication link 1726 and/or a wired communication link 1726a to a remote resource 1728 (e.g., a cloud resource) across network 1730. Various different examples of communication links 1726 and 1726a include a wireless connection, a wired connection, and/or a dedicated link, and in some examples, at least a portion is routed through the internet.

Although described in connection with an example computing device 1700, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to
create a first LLM prompt based on an input large language model (LLM) prompt, the first LLM prompt representing a first step toward generating a solution to the input LLM prompt;
submit the first LLM prompt to an LLM as a first sub-query, thereby resulting in the generation of a first LLM output;
create a second LLM prompt based on the input LLM prompt, the second LLM prompt representing a second step toward generating the solution to the input LLM prompt, the second LLM prompt including the first LLM output;
submit the second LLM prompt to the LLM as a second sub-query, thereby resulting in the generation of a second LLM output; and
cause the second LLM output to be displayed as the solution to the input LLM prompt in response to the input LLM prompt.

2. The system of claim 1, wherein the input LLM prompt includes a first sentence and a second sentence, wherein creating the first LLM prompt comprises creating the first LLM prompt to include at least the first sentence, wherein creating the second LLM prompt comprises creating the first LLM prompt to include at least the second sentence.

3. The system of claim 1, wherein the instructions are further operative to identify a pre-configured template that matches a form of the input LLM prompt, wherein creating the first LLM prompt comprises creating the first LLM prompt based on matching one or more portions of the input LLM prompt to one or more portions of the pre-configured template.

4. The system of claim 1, wherein the instructions are further operative to:
create a deconstruction LLM prompt based on the input LLM prompt, the deconstruction LLM prompt being formed to query the LLM to identify multiple sub-steps from within input LLM prompt; and
submit the deconstruction LLM prompt to the LLM, thereby generating a deconstruction LLM output that includes at least a first step and a second step,
wherein creating the first LLM prompt based on the input LLM prompt further includes creating the first LLM prompt based on the first step,
wherein creating the second LLM prompt based on the input LLM prompt further includes creating the second LLM prompt based on the second step.

5. The system of claim 1, wherein the instructions are further operative to:
create a verification LLM prompt based on the first LLM output;
submit the verification LLM prompt to the LLM, thereby generating a verification LLM output;
compare the verification LLM output to the solution based on a comparison metric; and
cause a result of the comparison to be displayed.

6. The system of claim 1, wherein the instructions are further operative to:
generate a graph that includes a first state node, a second state node, and one or more edges, the first state node representing an initial state of one or more variables identified by the input LLM prompt, the second state node representing a second state of the one or more variables;
identify a first edge connecting the first state node and the second state node, the first edge representing a trusted application of the input LLM query to the one or more variables, thereby resulting in a trusted solution;
identify one or more other edges connecting the first state node and the second state node, the one or more other edges representing application of the input LLM query via the LLM, thereby resulting in the solution; and
determine whether or not the graph commutes based on whether the solution matches the trusted solution.

7. The system of claim 1, further comprising an LLM computing device that is configured to:
receive the first LLM prompt from the processor;
generate the first LLM output based on applying the first LLM prompt as input to the LLM;
transmit the first LLM output to the processor;
receive the second LLM prompt from the processor;
generate the second LLM output based on applying the second LLM prompt as input to the LLM; and
transmit the second LLM output to the processor.

8. A computer-implemented method comprising:
creating a first large language model (LLM) prompt based on an input LLM prompt, the first LLM prompt representing a first step toward generating a solution to the input LLM prompt;
submitting the first LLM prompt to an LLM as a first sub-query, thereby resulting in the generation of a first LLM output;
creating a second LLM prompt based on the input LLM prompt, the second LLM prompt representing a second step toward generating the solution to the input LLM prompt, the second LLM prompt including the first LLM output;
submitting the second LLM prompt to the LLM as a second sub-query, thereby resulting in the generation of a second LLM output; and
transmitting the second LLM output as the solution to the input LLM prompt.

9. The method of claim 8, wherein the input LLM prompt includes a first sentence and a second sentence, wherein creating the first LLM prompt comprises creating the first LLM prompt to include at least the first sentence, wherein creating the second LLM prompt comprises creating the first LLM prompt to include at least the second sentence.

10. The method of claim 9, further comprising parsing the input LLM prompt based on one or more of sequence adverbs and temporal adverbs, wherein creating the first LLM prompt further comprises removing at least one adverb from the first sentence.

11. The method of claim 8, further comprising identifying a pre-configured template that matches a form of the input LLM prompt, wherein creating the first LLM prompt comprises creating the first LLM prompt based on matching one or more portions of the input LLM prompt to one or more portions of the pre-configured template.

12. The method of claim 8, further comprising:
creating a deconstruction LLM prompt based on the input LLM prompt, the deconstruction LLM prompt being formed to query the LLM to identify multiple sub-steps from within input LLM prompt; and
submitting the deconstruction LLM prompt to the LLM, thereby generating a deconstruction LLM output that includes at least a first step and a second step,
wherein creating the first LLM prompt based on the input LLM prompt further includes creating the first LLM prompt based on the first step,
wherein creating the second LLM prompt based on the input LLM prompt further includes creating the second LLM prompt based on the second step.

13. The method of claim 8, further comprising:
creating a verification LLM prompt based on the first LLM output;
submitting the verification LLM prompt to the LLM, thereby generating a verification LLM output;
comparing the verification LLM output to the solution based on a comparison metric; and
displaying a result of the comparison.

14. The method of claim 8, further comprising:
generating a graph that includes a first state node, a second state node, and one or more edges, the first state node representing an initial state of one or more variables identified by the input LLM prompt, the second state node representing a second state of the one or more variables;
identifying a first edge connecting the first state node and the second state node, the first edge representing a trusted application of the input LLM query to the one or more variables, thereby resulting in a trusted solution;
identifying one or more other edges connecting the first state node and the second state node, the one or more other edges representing application of the input LLM query via the LLM, thereby resulting in the solution; and
determining whether or not the graph commutes based on whether the solution matches the trusted solution.

15. A computer storage device having computer-executable instructions stored thereon, which, on execution by a computer, cause the computer to perform operations comprising:
creating a first large language model (LLM) prompt based on an input LLM prompt, the first LLM prompt representing a first step toward generating a solution to the input LLM prompt;
submitting the first LLM prompt to an LLM as a first sub-query, thereby resulting in the generation of a first LLM output;
creating a second LLM prompt based on the input LLM prompt, the second LLM prompt representing a second step toward generating the solution to the input LLM prompt, the second LLM prompt including the first LLM output;
submitting the second LLM prompt to the LLM as a second sub-query, thereby resulting in the generation of a second LLM output; and
displaying the second LLM output as the solution to the input LLM prompt in response to the input LLM prompt.

16. The computer storage device of claim 15, wherein the input LLM prompt includes a first sentence and a second sentence, wherein creating the first LLM prompt comprises creating the first LLM prompt to include at least the first sentence, wherein creating the second LLM prompt comprises creating the first LLM prompt to include at least the second sentence.

17. The computer storage device of claim 15, the operations further comprising identifying a pre-configured template that matches a form of the input LLM prompt, wherein creating the first LLM prompt comprises creating the first LLM prompt based on matching one or more portions of the input LLM prompt to one or more portions of the pre-configured template.

18. The computer storage device of claim 15, the operations further comprising:
creating a deconstruction LLM prompt based on the input LLM prompt, the deconstruction LLM prompt being formed to query the LLM to identify multiple sub-steps from within input LLM prompt;
submitting the deconstruction LLM prompt to the LLM, thereby generating a deconstruction LLM output that includes at least a first step and a second step,
wherein creating the first LLM prompt based on the input LLM prompt further includes creating the first LLM prompt based on the first step,
wherein creating the second LLM prompt based on the input LLM prompt further includes creating the second LLM prompt based on the second step.

19. The computer storage device of claim 15, the operations further comprising:
creating a verification LLM prompt based on the first LLM output;
submitting the verification LLM prompt to the LLM, thereby generating a verification LLM output;
comparing the verification LLM output to the solution based on a comparison metric; and
displaying a result of the comparison.

20. The computer storage device of claim 15, the operations further comprising:
generating a graph that includes a first state node, a second state node, and one or more edges, the first state node representing an initial state of one or more variables identified by the input LLM prompt, the second state node representing a second state of the one or more variables;
identifying a first edge connecting the first state node and the second state node, the first edge representing a trusted application of the input LLM query to the one or more variables, thereby resulting in a trusted solution;
identifying one or more other edges connecting the first state node and the second state node, the one or more other edges representing application of the input LLM query via the LLM, thereby resulting in the solution; and
determining whether or not the graph commutes based on whether the solution matches the trusted solution.
